(19) United States
(12) Patent Application Publication
(10) Pub. No.: US 2008/0154559 A1
(43) Pub. Date: Jun. 26, 2008

(54) Method and system for variable scale time management for simulation environments

(76) Inventors: Chethan Ram, Apex, NC (US); Nataraj Nagaratnam, Morrisville, NC (US); Michael Levi Fraenkel, Cary, NC (US)

Correspondence Address: MOORE & VAN ALLEN, PLLC For IBM, P.O. Box 13706, Research Triangle Park, NC, 27709, US

(21) Appl. No.: 11/548,910

(22) Filed: Oct. 12, 2006

(51) Int. Cl. G06G 7/48

(52) U.S. Cl. 703/6

(57) ABSTRACT

A system for variable scale time management in a simulation environment may include a simulation orchestrator to receive a job plan including a group of jobs and to execute a simulation of the group of jobs. The system may also include a scale time management (VSTM) component to factor an actual execution time for all jobs and to determine a scale-down time factor. The system may further include an output device to present results of the simulation based on the scale-down time factor.

### BACKGROUND OF THE INVENTION

The present invention relates to simulating processes and systems, and more particularly to a method and system for variable scale time management for simulation environments.

Simulation of a system or process provides an insight into the functioning of the system while avoiding the overhead of having real users utilize or test the system and having to coordinate resources for use by the system or process. Simulating systems or processes may exist in various domains. For example job scheduling, business process modeling, production management and other environments may be simulated. For those domains that take time into account, either they simulate the process to completion (no scaling back in time), or time is not a factor. The drawbacks of existing simulation solutions are that, either they have to wait for the duration of the actual process, or when the process can be simulated using a time factor, the time factor is constant for all job units. Accordingly, some processes or job units may not be capable of being simulated within a desired simulation time and time may be wasted waiting for simulation of some jobs or work units to complete that may not have a significant level of interest.

### BRIEF SUMMARY OF THE INVENTION

In accordance with an embodiment of the present invention, a system for variable scale time management in a simulation environment may include a simulation orchestrator to receive a job plan including a group of jobs and to execute a simulation of the group of jobs. The system may also include a variable scale time management (VSTM) component to factor an actual execution time for all jobs and to determine a scale-down time factor. The system may further include an output device to present results of the simulation based on the scale-down time factor. The output device may include hardware, software or some combination thereof.

In accordance with another embodiment of the present invention, a method for variable scale time management in a simulation environment may include determining a scale-down time factor based on a plurality of actual execution times for a group of jobs. The method may also include simulating an execution time of each job using the scale-down time factor.

In accordance with another embodiment of the present invention, a computer program product for variable scale time management in a simulation environment may include a computer usable medium having computer usable program code embodied therein. The computer usable medium may include computer usable program code configured to determine a scale-down time factor based on a plurality of actual execution times for a group of jobs. The computer usable medium may also include computer usable program code configured to simulate an execution time of each job using the scale-down time factor.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE SEVERAL VIEWS OF THE DRAWINGS

FIG. 1 is a block diagram of an exemplary system for variable scale time management for simulation environments in accordance with an embodiment of the present invention.

FIGS. 2A and 2B (collectively FIG. 2) are flow chart of an exemplary method for variable scale time management for simulation environments in accordance with an embodiment of the present invention.

FIG. 3 is a diagram of an example of a system including a variable time scale management feature for simulating another system or process in accordance with an embodiment of the present invention.

### DETAILED DESCRIPTION OF THE INVENTION

The following detailed description of embodiments refers to the accompanying drawings, which illustrate specific embodiments of the invention. Other embodiments having different structures and operations do not depart from the scope of the present invention.

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, radio frequency (RF) or other means.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

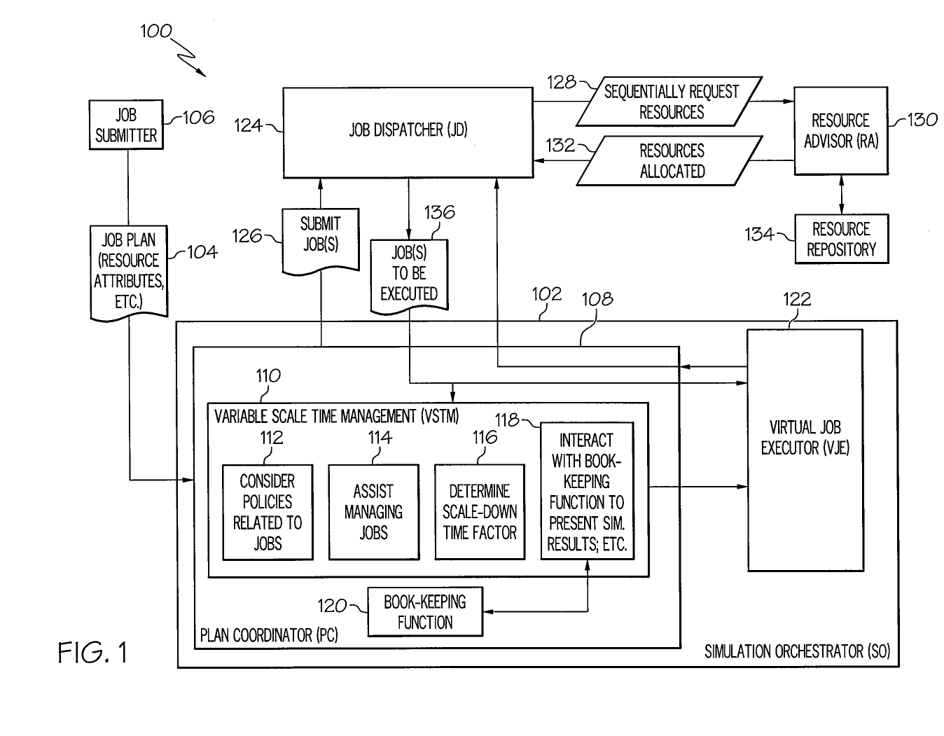

FIG. 1 is a block diagram of an exemplary system 100 for variable scale time management for simulation environments in accordance with an embodiment of the present invention. The system 100 may include a simulation orchestrator 102 to receive a job plan 104 or job matrix from a job submitter 106 or administrator. The job plan 104 may include a group of jobs that may define a particular system or process or a selected part of a system or process that a user desires to simulate. The simulation orchestrator 102 may execute a simulation of the group of jobs as described herein.

The job plan 104 may include information or data related to each job of the group of jobs. For example, the job plan may include an real-time or actual time period or estimated real-time period each job needs to execute, resource attributes or a set of resource requirements for each job, any sequence that some jobs may need to be executed relative to any other jobs, any rules or policies related to any jobs, e.g., any conditions that need to be fulfilled before a job can be executed, any resources or inputs that need to be available, etc.

The simulation orchestrator 102 may include a plan coordinator 108 to receive or accept the job plan 104. The plan coordinator 108 may sort the job plan 104 to schedule the group of jobs according to predetermined criteria. For example, the job coordinator 108 may sort jobs according to any rules or policies, in an order according to need for execution, according to an availability of resources or other criteria.

The simulation orchestrator 102 may also include a variable scale time management (VSTM) component 110. The VSTM component 110 may control the sequencing of work units or jobs in a “scaled” time to help analyze scheduling efficiency. The VSTM component 110 may include a module 112 to take into consideration policies or rules related to the jobs and a module 114 to assist in managing jobs and in controlling the sequencing and simulation of jobs in a simulation environment.

The VSTM component 110 may also include a module 116 to determine a scale-down time factor. The VSTM component 110 or module 116 may factor an actual execution time for all jobs and determine a scale-down time factor. The VSTM component 110 may also be adapted to vary the scale-down time factor for analysis of at least one selected job or the group of jobs that may be of particular interest for some reason. Accordingly, the VSTM component 110 or module 116 may speed up or slow down simulation for a selected job or jobs for more detailed analysis or evaluation. The variable scale time factor makes feasible simulation that would otherwise be waiting for potentially long durations (due to the inherent nature of the work units or jobs) or provides insufficient time to actually evaluate a particular job, set of jobs or work unit of particular interest relative to other jobs of the process or system.

Accordingly, the VSTM component 110 in the simulation orchestrator 102 may factor the wall-clock time for all work units or jobs and may compute a scale-down time factor based on which of these work units or jobs execute. Each job may be simulated to run or execute for this scale-down time instead of the actual time. In the example of simulating a scheduling system the work units or jobs may be dispatched after some processing that may occur with other components of the scheduling system. Thus the simulation may involve processing time due to inter-component interactions and work-unit execution simulation, the former being a “real” time element and the latter a simulated time element (scaled down). VSTM component 108 may include a bookkeeping module 118 to keep track and account for both time elements. Additionally, the VSTM component 108 may progress from time instances where a batch of work-units or jobs is scheduled to another batch of work-units or jobs to be scheduled. In essence the clock or simulation would virtually be “leap-frogging” to progressive time instances, and constantly computing the actual delay in scheduling the work units or jobs.

Thus, the VSTM component 110 of the present invention provides the advantage of efficiency in process analysis, or job analysis in the simulation system to which it may be applied. The variable scale time factor provides a way where multiple tasks, activities or jobs can be scaled to different levels based on their nature and desired simulation time. When analysis is about a particular part of the process, the variable scale time factor can reduce the simulation time for more detailed analysis of such activities. The bookkeeping module 118 may interface with a bookkeeping function 120 that may be part of the plan coordinator 108 to present the simulation results or permit analysis of the simulation results as described herein. Where information is taken from the bookkeeping module 118 or function 120, the variable scale time factor for each of the tasks may be taken into account. The output results may be computed in a way that tasks can be “scaled up” based on the scale-down factor, such that the results are illustrative of tasks of the same time factor.

The simulation orchestrator 102 may also include a virtual job executor 122 to simulate an execution time of each job using the scale-down time factor. The virtual job executor 122 may execute a loop corresponding to a simulated execution time. The simulated execution time may be a function of an actual execution time for the job divided by the scale-down time factor.

The system 100 may also include a job dispatcher 124 to request an allocation of any resources needed to execute each job or sequence of jobs. The plan coordinator 108 may submit a job 126 or sequence of jobs to the job dispatcher 124. The job dispatcher 124 may transmit a request 128 for an allocation of resources to a resource advisor 130. The requests 128 for allocation of resources may be submitted sequentially to the resource advisor 130. The resource advisor 130 may allocate the requested resources 132 depending upon availability from a resource repository 134. The job dispatcher 124 may dispatch a submitted job or sequence of jobs to be executed 136 in response to resources being allocated to execute the job or sequence of jobs in the simulation environment.

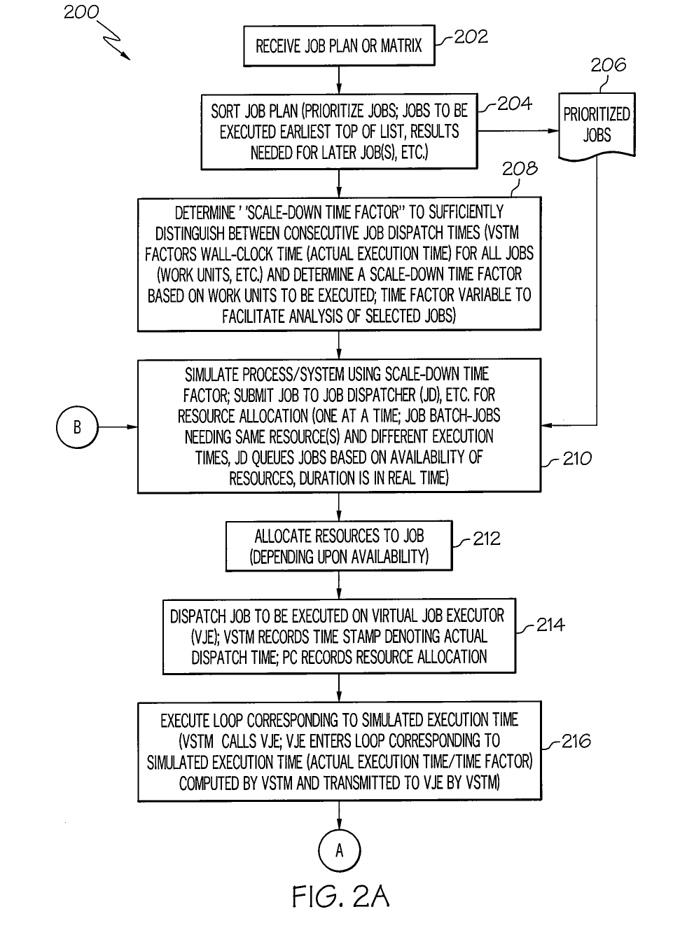

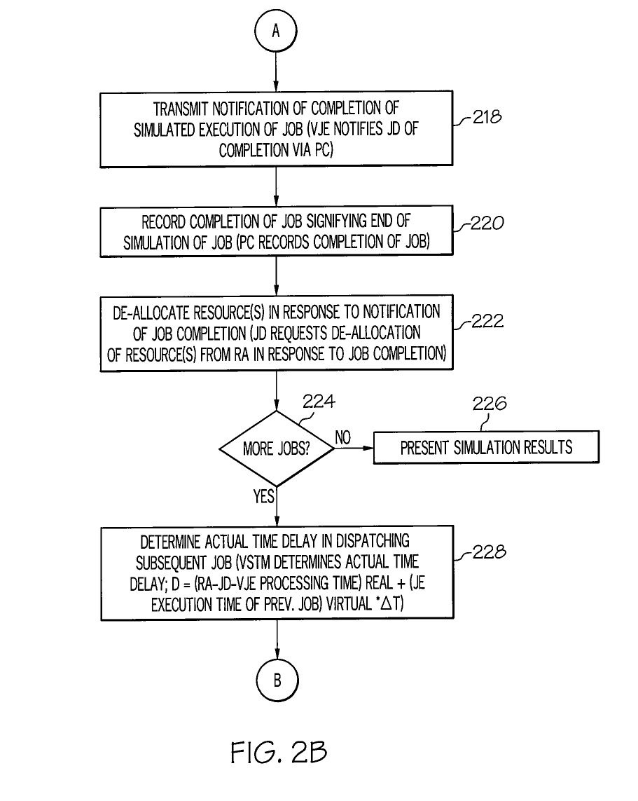

FIGS. 2A and 2B (collectively FIG. 2) are flow chart of an exemplary method 200 for variable scale time management for a simulation environment in accordance with an embodiment of the present invention. The method 200 may be embodied in and performed by the system 100 of FIG. 1. In block 202, a job plan or job matrix may be received. In block 204, the job plan may be sorted. For example, jobs that need to be executed earliest may be sorted at the top of a list of jobs or jobs that provide results for subsequent jobs may be scheduled before jobs that may need the results. A prioritized job list 206 or schedule of execution of jobs may be created.

In block 208, a scale-down time factor may be determined similar to that previously discussed. The scale-down time factor may be determined to sufficiently distinguish between consecutive job dispatch times. As previously described, a VSTM component, such as component 110 of FIG. 1 may factor wall-clock time (actual execution time) for all jobs, work units or the like, and determine a scale-down time factor based on jobs or work units to be executed. The scale-down time factor may be variable for different jobs or sequence of jobs to facilitate more detailed analysis or simulation of selected jobs or sequence of jobs or work units.

In block 210, the process or system may be simulated using the scale-down time factor or variable factor for each of the jobs or work units being simulated as part of the process or system. Similar to that previously described, a job or sequence of jobs may be submitted to a job dispatcher for resource allocation. The jobs may be submitted one at a time or a batch of jobs needing the same resource or resources and having different execution times may be submitted. The job dispatcher may queue jobs based on availability of resources. The duration may be in real-time.

In block 212, resources may be allocated to the job depending upon availability. In block 214, a job may be dispatched to be executed on a virtual job executor (VJE) in response to allocation of any needed resources. The virtual job executor may be the same as virtual job executor 122 of FIG. 1. A VSTM component similar to component 110 in FIG. 1 may record a time stamp denoting actual dispatch time of the job. The resource allocation may be recorded by a plan coordinator, such as plan coordinator 108 of FIG. 1.

In block 216, a loop corresponding to a simulated execution time may be executed. The simulated execution time may be a function of the actual or real-time execution time divided by the scale-down time factor. As previously discussed the scale-down time factor may be determined by the VSTM component and transmitted to the variable job executor.

In block 218, a notification of completion of the simulated execution of the job or sequence of jobs may be transmitted by the virtual job executor. The virtual job executor may notify the job dispatcher of the completion of the simulation via the plan coordinator of the simulation orchestrator. The plan coordinator may record completion of the job signifying end of the simulation of the job.

In block 222, any allocated resources to simulate the job or sequence of jobs may be de-allocated in response to notification of the job completion. The plan coordinator may notify the job dispatcher that the job simulation is complete. The job dispatcher may then request de-allocation of the resource or resources from the resource advisor (RA) in response to the job completion.

In block 224, a determination may be made if there are any more jobs to simulate. If there are no more jobs to simulate, the results of the simulation may be presented in block 226. If there are more jobs to simulate. For example, there are more jobs in the queue of the job dispatcher to simulate; the method 200 may advance to block 228. In block 228, an actual delay time in dispatching a subsequent job may be determined. The method 200 may then return to block 210 to simulate the next job or sequence of jobs and the method 200 may proceed as previously described. The VSTM component may determine an actual time delay between jobs. The actual time delay may be represented by the following equation:

D=(RA-JD-VJE Processing Time) Real+(JE Execution Time of Previous Job) Virtual*ΔT

Where RA-JD-VJE Processing Time is the real-time processing time due to the resource advisor (RA), job dispatcher OD) and virtual job executor (VJE), and JE Execution Time of Previous Job is the virtual execution time of the previous jobs on the job executor multiplied by the simulation time factor.

The variable scale time factor for each of the tasks or jobs may be taken into account. The output results may be computed in a way that tasks or jobs can be “scaled up” based on the scale-down factor, such that the results may be illustrative of tasks of the same time factor or similar execution times.

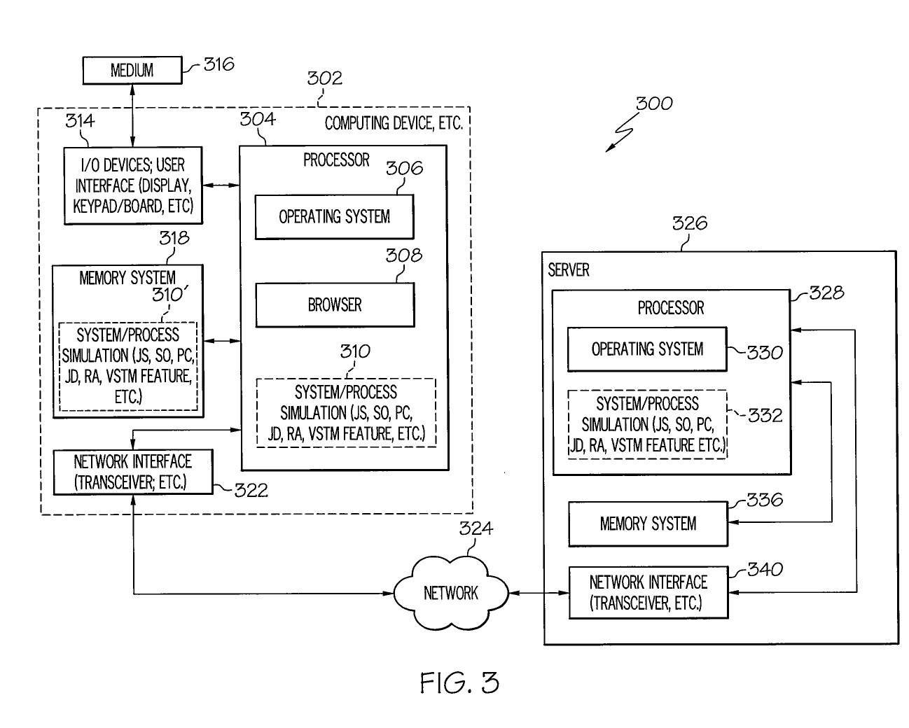

FIG. 3 is a block schematic diagram of an exemplary system 300 and a computing device 302 or the like including a variable time scale management feature for simulating another system or process in accordance with an embodiment of the present invention. The computing device 302 may be a computer system, mobile computing system or the like. The system 100 of FIG. 1 and the method 200 of FIG. 2 may be embodied in the system 300 or computing device 302.

The computing device 302 may include a processor 304. An operating system 306 may run on the processor 304 to control overall operation of the computing device 302. The computing device 302 may also include a browser 308 for accessing web sites or the like on a network, such as the Internet, a private network or other type of network. The computing device 302 may also include a system or process simulation module 310 or the like that may be operable on the processor 304. The system 100 and method 200 may be embodied in the simulation module 210. Accordingly, the module 210 may include a variable scale time management feature or component similar to VSTM component 110 of FIG. 1. The module 210 may also include the other elements or components of the system 100 of FIG. 1.

The computing device 302 may also include an input/output (I/O) device or devices and a user interface 314. The user interface 314 may include a display or monitor, keypad, keyboard or the like for a user to enter data and perform the functions described with respect to method 200. The display or monitor of the I/O devices 314 may be used to present results of a simulation to a user. The I/O device or devices 314 may also include disk drives or the like to download data from a computer useable or readable medium 316 as defined herein. The I/O device or devices 314 may include hardware, software or some combination thereof.

The computing device 302 may also include a memory system 318. The system/process simulation module 210′ may be stored on the memory system 318 and uploaded to the processor 304 for operation when needed or accessed.

The computing device 302 may also include a network interface 322 for accessing a network 324. The network interface 322 may be or may include a wireless transceiver for communicating with the network 324 via radio signals. The network 324 may be a wireless communications network, wire line communications network or a combination wire line and wireless communications network. The network 324 may also be or include the Internet or other network.

The computing device 302 may access a server 326 or other elements or components that may be part of the system 300 via the network 324. The server 326 may include a processor 328. An operating system 330 may be operable on the processor 328 to control operation of the server 326 and to perform various other functions, such as system or process simulations and the like.

In some embodiments of the present invention, a system/process simulation 332 or similar application may be operable on the processor 330. The simulation application 332 may be provided in some embodiments of the system 300 in lieu of simulation application 310 in the computing device 302. In other embodiments of the system 300, the simulation application 332 may function in coordination with the simulation application 310 in the computing device 310.

The server 326 may also include a memory system 336. The simulation application 332 may be stored on the memory system 336 and uploaded to the processor 328 for operation when needed or accessed.

The server 326 may also include a network interface 340 for accessing the network 324. The network interface 340 may be similar to network interface 322 in the computing device 302. The network interface 340 may also be or may include a transceiver for accessing the network 324 via a wireless, wire line or combination wireless and wire line connection.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A system for variable scale time management in a simulation environment, comprising:
a simulation orchestrator to receive a job plan including a group of jobs and to execute a simulation of the group of jobs;
a variable scale time management (VSTM) component to factor an actual execution time for all jobs and to determine a scale-down time factor; and
an output device to present results of the simulation based on the scale-down time factor.

2. The system of claim 1, wherein the VSTM component comprises:
a module to consider policies related to the group of jobs in simulating the jobs in the simulation environment;
a module to assist with managing the group of jobs in the simulation environment; and
a module to interact with a book-keeping function to permit presentation of the results of the simulation.

3. The system of claim 1, wherein the VSTM component is adapted to vary the scale-down time factor for analysis of at least one selected job of the group of jobs.

4. The system of claim 1, further comprising a virtual job executor to simulate an execution time of each job using the scale-down time factor.

5. The system of claim 4, wherein the virtual job executor executes a loop corresponding to a simulated execution time, the simulated execution time comprising a function of an actual execution time for the job divided by the scale-down time factor.

6. The system of claim 1, further comprising a plan coordinator to accept the job plan and to sort the job plan to schedule the group of jobs in an order of need for execution.

7. The system of claim 1, further comprising a job dispatcher to request an allocation of resources to execute each job.

8. The system of claim 1, further comprising a resource advisor to receive a request for an allocation of resources and to allocate a requested resource depending upon an availability of the requested resource.

9. The system of claim 1, further comprising:
a plan coordinator to accept the job plan and to sort the job plan to schedule the group of jobs in an order of need for execution;
a job dispatcher to request a resource allocation in response to receiving at least one of the group of jobs from the plan coordinator;
a virtual job executor to simulate execution of a dispatched job in response to receiving the dispatched job from the job dispatcher, wherein a simulated execution time for the dispatched job is determined by the VSTM component and includes a fraction of the actual execution time for the dispatched job based on the scale-down time factor.

10. The system of claim 9, wherein the virtual job executor is adapted to notify the job dispatcher in response to completion of simulating execution of the dispatched job, and wherein the job dispatcher is adapted to request de-allocation of any resources in response to a notification of completion of simulating execution of the dispatched job.

11. A method for variable scale time management in a simulation environment, the method comprising:
determining a scale-down time factor based on a plurality of actual execution times for a group of jobs; and
simulating an execution time of each job using the scale-down time factor.

12. The method of claim 11, further comprising:
determining a simulated execution time as a function of an actual execution time for the job divided by the scale-down time factor; and
executing a loop corresponding to the simulated execution time.

13. The method of claim 11, further comprising sorting the group of jobs to schedule the group of jobs for simulation in an order of need for execution.

14. The method of claim 11, further comprising:
requesting an allocation of resources for a submitted job; and
allocating a requested resource depending upon an availability of the requested resource.

15. The method of claim 11, further comprising varying the scale-down time factor to permit analysis of at least one selected job of the group of jobs.

16. The method of claim 11, further comprising presenting results of the simulation based on the scale-down time factor.

17. The method of claim 11, further comprising permitting a time scaling-up of a selected job based on the scale-down time factor to present results illustrative of jobs having a similar execution time.

18. A computer program product for variable scale time management in a simulation environment, the computer program product comprising:
a computer usable medium having computer usable program code embodied therein, the computer usable medium comprising:
computer usable program code configured to determine a scale-down time factor based on a plurality of actual execution times for a group of jobs; and
computer usable program code configured to simulate an execution time of each job using the scale-down time factor.

19. The computer program product of claim 18, wherein the computer usable medium further comprises:
computer usable program code configured to determine a simulated execution time as a function of an actual execution time for the job divided by the scale-down time factor; and
computer usable program code configured to execute a loop corresponding to the simulated execution time.

20. The computer program product of claim 18, further comprising computer usable program code configured to vary the scale-down time factor to permit analysis of a selected job of the group of jobs.
